(19) United States
(12) Patent Application Publication
(10) Pub. No.: US 2011/0238386 A1
(43) Pub. Date: Sep. 29, 2011

(54) Reversible-Orientation Joint

(76) Inventor: Michael Kelly, Ottawa (CA)

(21) Appl. No.: 12/732,855

(22) Filed: Mar. 26, 2010

(51) Int. Cl. G06F 17/50; G06G 7/48

(52) U.S. Cl. 703/1; 703/6

(57) ABSTRACT

Embodiments of the invention may be used for the design or simulation of articulated assemblies to transform the definitions of the joints they comprise by reversing their orientations. That is, to a method for defining in software a representation of a physical joint which is oriented, that is, one which designates one joined segment to be the reference and one joined segment to be mobile, such that the joint can be transformed into a joint with comparable behavioral properties and constraints, but with the reverse relationship of reference and mobile segments.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTINGS, A TABLE, OR A COMPUTER PROGRAM LISTING COMPACT DISK APPENDIX

Not Applicable

### BACKGROUND OF THE INVENTION

1. Field of the Invention

Embodiments of the invention relate to the design and simulation of articulated assemblies, such as robots or animated characters. More specifically, embodiments of the invention are directed to the joints between the segments in such assemblies.

2. Description of the Related Art

Articulated assemblies are comprised of rigid or flexible segments of arbitrary shape, and the joints between them. Representations of articulated assemblies and the properties and behaviors of their constituent parts are central to the design and simulation of those assemblies.

In a design system, representations of articulated assemblies are constructed by specifying an initial segment, generally considered to be the root of the assembly, and then by incrementally adding segments to the assembly. Adding a segment to the assembly is done by adding one or more joints to join that segment to one or more existing segments. Similarly, groups of elements representing subassemblies may be added to the assembly under construction. The properties and behaviors of the segments and joints in the assembly may be modified as part of the design process. Design may be a precursor to constructing a physical assembly.

In a simulation system, which may be unified with a design system, the behaviors of articulated assemblies can be exercised, i.e., the states of its joints can be changed along their specified degrees of freedom. An assembly may be exercised manually through a user interface or via scripts to automate the process, and may be done with the assembly in isolation or in a simulated environment. A simulated environment typically contains a support surface, obstacles, a force of gravity, and may allow for interactions between different assemblies. Simulation may be done to study and establish the overall behavior of an assembly, or as the basis for rendering the assembly to generate a computer animation. In either case, simulation may be a precursor to constructing a physical assembly, based on the specifications of the simulated one.

In object-oriented systems, representations of articulated assemblies may be contained in the Members and Methods of software Classes. Properties and behaviors of individual segments and joints may be embodied in the Members and Methods of single software Classes, or they may be distributed across multiple Classes. In non-object-oriented systems, representational information may be in local or global variables, and in local or global routines, depending on the characteristics and features of the programming language or languages involved, and the characteristics of the environments in which the software is run.

Where responsiveness or realtime performance is important, representations may be created using low-level languages, possibly directly in machine code, which may be much more efficiently executed. In many systems, a combination of technologies is used; often the user interface and visual representations are constructed using object-oriented technology, while representations used for computing the states of assembly elements are constructed using lower level languages or machine code to unsure acceptable performance.

While a single joint may involve more than two segments, a complex joint involving more than two segments is generally decomposed into a set of simpler joints that each join pairs of segments.

In their simplest form, joints specify points on a pair of segments that coincide; such joints are of limited use. More useful joints are given properties, most importantly the axes and ranges of motion of their degrees of freedom.

Joints between segment pairs in an assembly have, in the general case, six degrees of freedom: translations in three dimensions, and rotations along three axes, relative to reference points on each of the segments being joined. Specific joint types are defined by which of these degrees of freedom allow variation, and which have fixed values.

Examples of joints are:
1) a hinge joint, like a knee, which allows variation along one rotational axis, while the remaining rotational values are fixed, and the contact point between the two segments is fixed, i.e., no translational variation is allowed,
2) a ball-and-socket joint, like a shoulder, which allows variation along all three degrees of rotational freedom—the arm can swing, it can be raised, and it can twist—while the contact point is fixed, i.e., no translational variation is allowed, and
3) a piston joint, like the joint between a keyboard key and the keyboard body, which allows translational variation along one axis (the key press direction) while remaining translationally fixed in other directions (it remains at the same place on the keyboard) and allowing no rotational variation.

The amount of variation for a rotational degree of freedom may be specified by upper and lower bounds on the angles of rotation. The amount of variation for a translational degree of freedom may be defined by upper and lower bounds on the distances of translation. In either case, where the amount of variation allowed is zero or effectively zero, the degree of freedom is considered fixed. In the case of rotational degrees of freedom, the upper and/or lower bound may be infinite, allowing the joint to rotate without constraint in one or both directions.

Existing systems for the design and simulation of articulated assemblies provide models for various types of joint. Some of these systems are complete design environments with complex user interfaces; other systems are essentially libraries of functional elements representing segments and joints, and include the ability to simulate assemblies created using those elements.

Examples of systems for the design and simulation of articulated assemblies are
1) Maya, a product of Autodesk Inc., used to create and simulate artificial characters,
2) AutoCAD, a product of Autodesk Inc., used to create and simulate elements in a mechanical design environment,
3) Endorphin, a product of Natural Motion Inc., used to create and simulate artificial characters,
4) the Open Dynamics Engine, an open-source software project containing a library of joint and segment definitions, and a simulation engine for assemblies created using those elements, and
5) the Newton Game Dynamics physics engine, a proprietary software product containing a library of joint and segment definitions, and a simulation engine for assemblies created using those elements.

By convention joints are defined with fixed orientations, i.e., one segment of a joint is considered the reference, while the other is considered to be mobile with respect to the reference.

With respect to design, joints with fixed orientations are sufficient, but they limit the alternatives of the user during the design process. Reversible joints increase the flexibility of the design environment.

For example, being able to reverse joints allows the user to change which segment in an assembly is considered the root of the graph of segments. Many of the characteristics of a joint may be determined by the characteristics of the mobile segments—indeed the mobile sub-graphs—to which they are associated. Reversing a joint changes the relationship between the segments and sub-graphs it joins, and so may change, and possibly simplify, how its characteristics are determined.

As another example, being able to reverse joints also allows a user to arbitrarily remove segments from an assembly, regardless of when or where they were added, and with what initial characteristics.

With respect to simulation, joints with fixed orientations are sufficient, but they constrain the simulation engine to perform calculations to compute the position of the segment which is always in the mobile role relative to the segment which is always in the reference role. Particularly, but not only, when the simulated environment puts constraints on the position or motion of the mobile segment, this can be very inefficient. It can be very advantageous computationally to reverse the orientations of some or all of the joints involved in the simulation in order to propagate environmental constraints through the sequence of segments in the assembly.

Accordingly, there remains a need in the art for a joint which can be reversed with respect to which segment is considered the reference and which segment is considered mobile.

### BRIEF SUMMARY OF THE INVENTION

The present invention generally provides a method for determining the specifications and state values of a joint between a first, reference, segment and a second, mobile, segment using the specifications of a joint between the same two segments in the reverse roles, such that the positions of the first and second segments in a global coordinate system remain constant. One embodiment of the invention is a software Class containing:
1) Member values representing the identities of the reference and mobile segments being joined,
2) Member values representing the current rotational and translational state values of the joint position relative to the reference segment,
3) Member values representing the upper and lower bounds on the rotational and translational state values of the joint, and
4) a Method which, when called, exchanges the identities of the reference and mobile segments, computes rotational and translational state values that correspond to a joint state relative to the new reference segment, and computes values for the upper and lower bounds on the joint state values with respect to the new reference segment.

A second embodiment of the invention contains the elements of the first embodiment, while simultaneously maintaining a first set of state values associated with one orientation of the joint and a second set of state values associated with the reverse orientation of the joint. In this embodiment, being in a first orientation implies making use of the first set of state values, and reversing the orientation implies making use of the second set of state values.

A third embodiment of the invention contains the elements of the first embodiment, while using different systems of coordinates for the joint's degrees of freedom depending on the joint's orientation. That is, the degrees of freedom of the joint would be specified using one system of coordinates with the first segment the reference and the second segment mobile, and in a second system of coordinates with the first segment mobile and the second segment the reference.

A fourth embodiment of the invention contains the elements of the first embodiment, while allowing the effective upper and lower bounds on the degrees of freedom to differ depending on the joint's orientation. That is, when reversing the joint, the upper and lower bounds in the reversed orientation do not correspond to the same ranges of relative first and second segment relationships as existed in the unreversed orientation. In this embodiment, a reversing of the joint is not allowed if that operation would result in the violation of the constraints specified by the bounds on any one degree of freedom.

A fifth embodiment of the invention provides the Method described in the first embodiment in one software Class, which operates on the specifications of a joint as described in the first embodiment contained in another software Class.

A sixth embodiment of the invention provides a method for performing the computations defined for the Method described in the first embodiment, but in a non-object-oriented environment, i.e., where the specifications of the joint, its current state, and the computations defined are not contained in software Classes. Rather the specifications are in separate local or global variables, and the instructions which perform the computation are in one or more software routines contained in the global software space.

### BRIEF DESCRIPTION OF THE SEVERAL VIEWS OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiment.

FIG. 1 is a diagram of a reversible-orientation joint allowing variation along three rotational degrees of freedom, according to one embodiment of the present invention.

FIG. 2 is a diagram of the reversible-orientation joint in FIG. 1 showing it in its two possible orientations, according to one embodiment of the present invention.

FIG. 3 is a diagram of a reversible-orientation joint allowing variation along two rotational degrees of freedom, according to one embodiment of the present invention. In the orientation depicted, the reference segment is horizontal and one degree of freedom allows rotation of the mobile segment up and down, designated “UpDown”, while the other allows rotation of the mobile segment left and right, designated “LeftRight”.

FIG. 4 is a diagram of the reversible-orientation joint in FIG. 3, but in the reverse orientation, according to one embodiment of the present invention. In the orientation depicted, the joint also allows variation along two rotational degrees of freedom, but illustrates the use of a different coordinate system; one degree of freedom allows rotation of the mobile segment about an axis perpendicular to the reference segment's length, designated “Swing”, while the other allows rotation of the mobile segment about an axis parallel to the reference segment's length, designated “Rotation”.

FIG. 5 is a diagram of the joint in FIG. 3 and FIG. 4 showing examples of its states in its two possible orientations, according to one embodiment of the present invention.

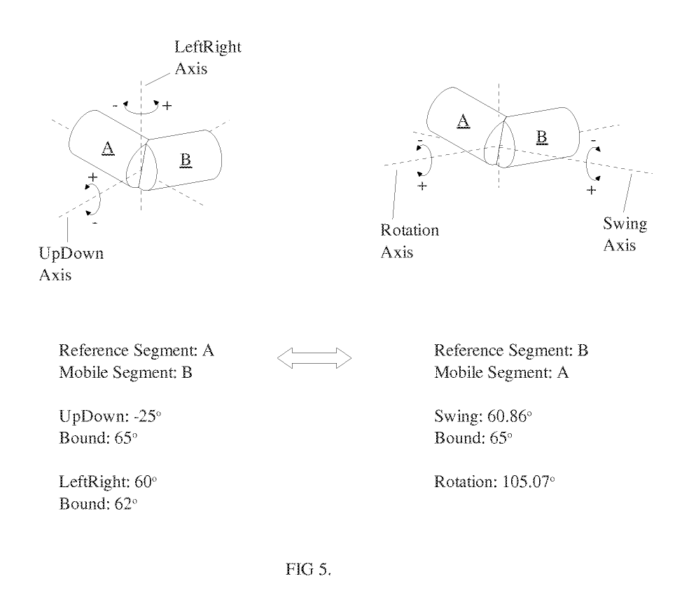

### DETAILED DESCRIPTION OF THE INVENTION

Embodiments of the invention provide a method to reverse the relationship between the reference and mobile segments of a joint while maintaining the relative positions of those segments in a global coordinate space. That is, a method for exchanging the identities of the reference and mobile segments of the joint and for computing the positional values along each degree of freedom for the new mobile segment with respect to the new reference segment from the positional values associated with the original mobile segment with respect to the original reference segment.

In the following, reference is made to embodiments of the invention. However, it should be understood that the invention is not limited to specifically described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a software Class for a joint allowing variation along the three degrees of rotational freedom, and no translational variation. The Class contains, but is not limited to:
1) a first string identifier for the reference segment,
2) a second string identifier for the mobile segment,
3) three instances of a sub-Class which specifies the upper bound, lower bound and current state value of the joint along a degree of freedom, one for each degree of freedom for this type of joint, a first degree of freedom designated “Swing”, which allows rotation of the mobile segment about an axis perpendicular to the reference segment's length, a second degree of freedom designated “Rotation”, which allows rotation of the mobile segment about an axis parallel to the reference segment's length, and a third degree of freedom designated “Twist”, which allows rotation of the mobile segment about an axis parallel to its own length,
4) a “Reverse” method, which exchanges the identifiers for the mobile and reference segments, computes the values associated with the rotation degree of freedom in the new orientation from the values associated with the twist degree of freedom in the original orientation, and computes the values associated with the twist degree of freedom in the new orientation from the values associated with the rotation degree of freedom in the original orientation, as follows:
   a) ReferenceSegmentIdentifier_{new}=MobileSegmentldentifier_{original}
   b) MobileSegmentIdentifier_{new}=ReferenceSegmentIdentifier_{original}
   c) SwingPos_{new}=SwingPos_{original}
   d) SwingLowerBound_{new}=SwingPos_{new}−(SwingPos_{original}−SwingLowerBound_{original)}
   e) SwingUpperBound_{new}=SwingPos_{new}+(SwingUpperBound_{original}−SwingPos_{original})
   f) RotationPos_{new}=180°−TwistPos_{original}
   g) RotationLowerBound_{new}=RotationPos_{new}−TwistUpperBound_{original}−TwistPos_{original}
   h) RotationUpperBound_{new}=RotationPos_{new}+(TwistPos_{original}−TwistLowerBound_{original})
   i) TwistPos_{new}=180°−RotationPos_{original}
   j) TwistLowerBound_{new}=TwistPos_{new}−(RotationUpperBound_{original}−RotationPos_{original})
   k) TwistUpperBound_{new}=TwistPos_{new}−(RotationPos_{original}−RotationLowerBound_{original})

A sub-Class specifying a degree of freedom, contains:
1) a first read-only floating point value representing the current state value for the joint along this degree of freedom,
2) a second read-only floating point value representing the upper bound for this degree of freedom,
3) a third read-only floating point value representing the lower bound for this degree of freedom,
4) a first Method, for specifying the position of the joint along this degree of freedom; limiting it to be between the upper bound (in 2)) and the lower bound (in 3)),
5) a second Method, for specifying the upper bound (in 2)) for this degree of freedom, limiting it to be between the lower bound (in 3)) and 360°, and which has the side effect of calling the first Method (in 4)) passing in the current state value (in 1)),
6) a third Method, for specifying the lower bound (in 3)) for this degree of freedom, limiting it to be between 0° and the upper bound (in 2)), and which has the side effect of calling the first Method (in 4)) passing in the current state value (in 1)).

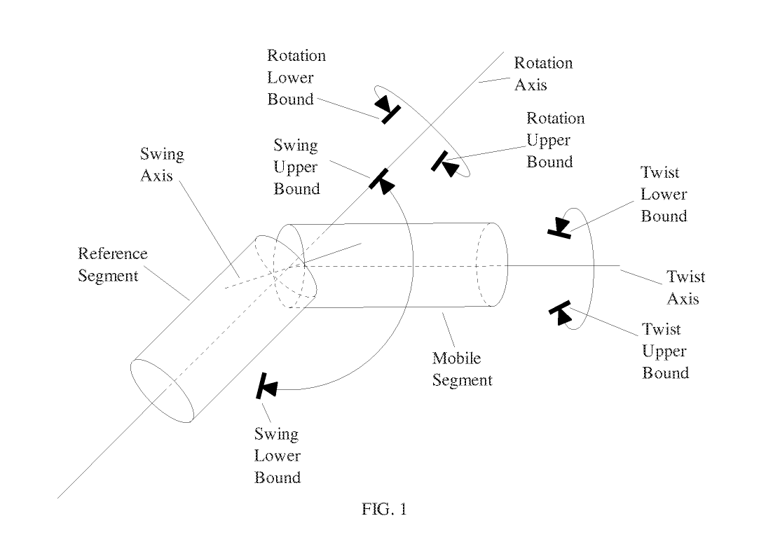

FIG. 1 shows an example of a joint of this type as it might be represented to a user in a design or simulation system.

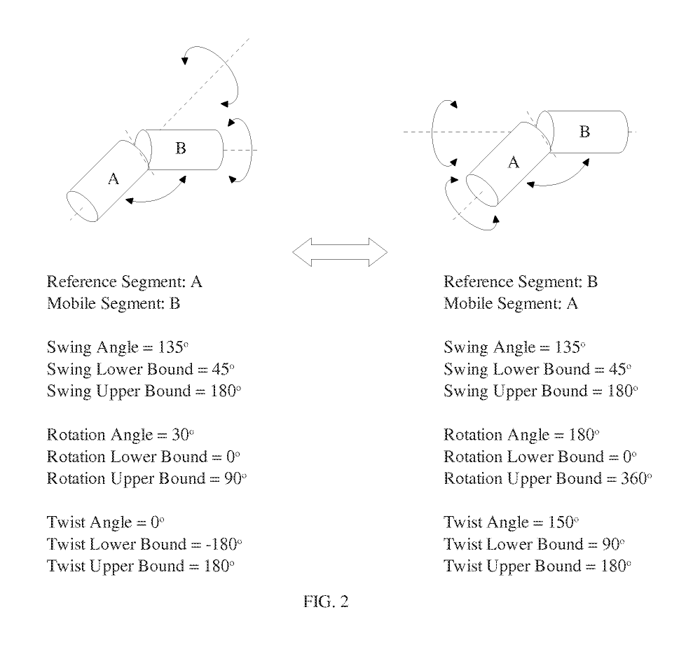

FIG. 2 shows an example of a joint of this type before and after it is reversed, as it might be represented to a user in a design or simulation system in either of those states.

A second embodiment of the invention is implemented as a software Class for a joint allowing variation along the two degrees of rotational freedom, and no translational variation. In addition, the coordinate systems in which the degrees of freedom are defined differ between the two orientations of the joint.

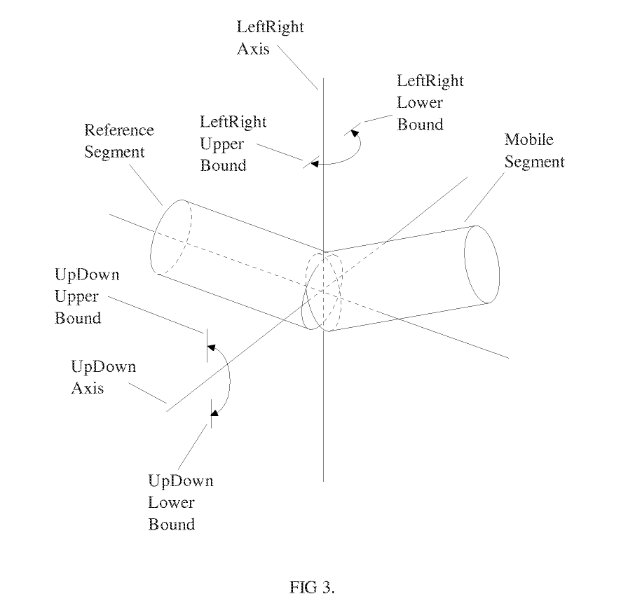

In a first orientation, that is with a first segment designated to be the reference and a second segment designated to be mobile, a first degree of freedom allows rotation of the mobile segment along an axis perpendicular to the reference segment's length, while a second degree of freedom allows rotation of the mobile segment along an axis perpedicular to both the reference segment's length and to the axis of rotation of the first degree of freedom. This coordinate system will be referred to as Rectangular. In an appropriately chosen reference frame where the reference segment lies horizontal, the first degree of freedom allows the mobile segment to swing up and down, while the second degree of freedom allows the mobile segment to swing to the left and right. For simplicity, the first degree of freedom is designated “UpDown” and the second degree of freedom is designated “LeftRight”. This orientation of the joint is illustrated in FIG. 3.

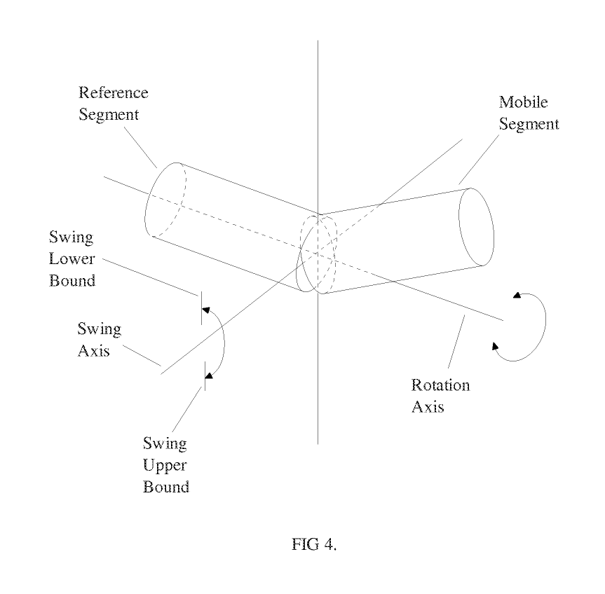

In a second, reverse, orientation, that is with the first segment designated to be the mobile segment and the second segment designated to be the reference, a first degree of freedom allows the rotation of the mobile segment along an axis perpendicular to the reference segment's length, while a second degree of freedom allows the rotation of the mobile segment along an axis parallel to the reference segment's length in such a way as to maintain a constant torsional relationship between the two. That is, the mobile segment cannot twist with respect to the reference segment, as is also the case in the first, unreversed, orientation. This coordinate systems will be referred to as Polar. In this orientation, the first degree of freedom is designated “Swing” and the second degree of freedom is designated “Rotation”. This orientation is illustrated in FIG. 4.

For simplicity the greatest magnitude of rotation for the UpDown and LeftRight degrees of freedom in the Rectangular coordinate system, and for the Swing degree of freedom in the Polar coordinate system, is 90°.

A joint so defined is consistent across its two orientations with respect to the absolute positional relationships possible between the two segments being joined, while allowing computation using difference coordinate systems for the two possible orientations, as may be advantageous in a design or simulation system.

A software Class for this embodiment would contain:
1) a first string identifier for the reference segment,
2) a second string identifier for the mobile segment,
3) a sub-Class containing the specifications of the degrees of freedom and their current states for the current joint orientation, one possible sub-Class representing the Rectangular coordinate system and one possible sub-Class representing the Polar coordinate system,
4) a first Method, which returns an instance of a sub-Class for the Rectangular coordinate system when passed in a sub-Class for the Polar coordinate system, POLAR, by executing the following steps:
   a) instantiate a new instance of the Rectangular coordinate system sub-Class, RECT,
   b) set the rectangular UpDown upper and lower bound value using its third method to the value:

RECT.Bound_{UpDown}=POLAR.Bound_{Swing}
c) set the rectangular UpDown position, Pos_{UpDown}, using its second method to the value:

$$RECT \cdot {Pos}_{UpDown} = {tan}^{- 1} ( \frac{( cos ( POLAR \cdot {Pos}_{Rotation} ) * sin ( POLAR \cdot {Pos}_{Swing} ) )}{cos ( POLAR \cdot {Pos}_{Swing} )} )$$

d) set the rectangular LeftRight position, Pos_{LeftRight}, using its first method to the value:

$$RECT \cdot {Pos}_{LeftRight} = {tan}^{- 1} ( \frac{sin ( POLAR \cdot {Pos}_{Rotation} ) * sin ( POLAR \cdot {Pos}_{Swing} )}{cos ( POLAR \cdot {Pos}_{Swing} )} )$$

5) a second Method, which returns an instance of a sub-Class for the Polar coordinate system when passed in a sub-Class for the Rectangular coordinate system, by executing the following steps:
   a) instantiate a new instance of the Polar coordinate system sub-Class, POLAR,
   b) set the single Swing upper and lower bound value in the Polar sub-Class using its third method as follows:

POLAR.Bound_{Swing}=RECT.Bound_{UpDown}
c) set the polar Swing position, Pos_{Swing}, in the Polar sub-Class using its first method as follows:

$$POLAR \cdot {Pos}_{Swing} = {cos}^{- 1} ( \frac{1}{\sqrt{( {tan}^{2} ( RECT \cdot {Pos}_{UpDown} ) * {tan}^{2} ( RECT \cdot {Pos}_{LeftRight} ) + 1}} )$$

d) set the polar Rotation position, Pos_{Rotation}, in the Polar sub-Class using its second method as follows:

$$POLAR \cdot {Pos}_{Rotation} = {tan}^{- 1} ( \frac{tan ( RECT \cdot {Pos}_{LeftRight} )}{tan ( RECT \cdot {Pos}_{UpDown} )} ) , \\ RECT \cdot {Pos}_{UpDown} \geq 0$$

$$180 ° + {tan}^{- 1} ( \frac{tan ( RECT \cdot {Pos}_{LeftRight} )}{tan ( RECT \cdot {Pos}_{UpDown} )} ) , RECT \cdot {Pos}_{UpDown} < 0$$

6) a third Method, the “Reverse” Method, which exchanges the identifiers for the mobile and reference segments, and which itself calls either the first Method (in 4)) or second Method (in 5)), passing in the current sub-Class (in 3)) and replacing the current sub-Class (in 3)) with the returned value.

A first sub-Class specifying the degrees of freedom and their current states for the Rectangular coordinate system would contain:
1) a first read-only floating point value, representing the current state value (Pos_{UpDown}) of the joint along the first degree of freedom, designated “UpDown”, where a state value of zero means that the mobile segment is in the same horizontal plane as the reference segment and the angle subtended by the reference and mobile segments is greater than 90°,
2) a second read-only floating point value, representing the current state value (Pos_{LeftRight}) of the joint along the second degree of freedom, designated “LeftRight”, where a state value of zero means that the mobile segment is in the same vertical plane as the reference segment and the angle subtended by the reference and mobile segments is greater than 90°,
3) a third read-only floating point value (Bound_{UpDown}), representing the magnitude of the upper, positive, and the lower, negative, bounds of the first degree of freedom,
4) a fourth read-only floating point value (Bound_{LeftRight}), representing the magnitude of the upper, positive, and the lower, negative, bounds of the second degree of freedom,
5) a first Method, for specifying the state value for the joint along the second degree of freedom (in 2)), limiting it to be between the upper and lower bounds for that degree of freedom (in 4)),
6) a second Method, for specifying the position for the joint along the first degree of freedom (in 1)), limiting it to be between the upper and lower bounds for that degree of freedom (in 3)), and which has the side effects of setting the value for the magnitude of the upper and lower bounds for the second degree of freedom (in 4)) as follows:

Bound_{LeftRight}=cos⁻¹(cos(Bound_{UpDown})/cos(Pos_{UpDown}))
and then calling the first Method (in 5)) passing in the current state value of the joint along the second degree of freedom (in 2)),
7) a third Method, for specifying the value for the magnitude of the upper and lower bounds for the first degree of freedom (in 3)), limiting it to be between 0° and 90°, and which itself calls the second Method (in 6)) passing in the current position of the joint along the first degree of freedom (in 1)).

A second sub-Class specifying the degrees of freedom and their current states for the Polar coordinate system would contain:
1) a first read-only floating point value (Pos_{Swing}), representing the current state value of the joint along the first degree of freedom, designated “Swing”, where a position of zero means that the mobile segment is colinear with the reference segment and the angle subtended by the reference and mobile segments is greater than 90°,
2) a second read-only floating point value (Pos_{Rotation}), representing the current state value of the joint along the second degree of freedom, designated “Rotation”,
3) a third read-only floating point value (Bound_{Swing}), representing the magnitudes of the upper, positive, and lower, negative, bounds of the first degree of freedom,
4) a first Method, for specifying the state value for the joint along the first degree of freedom (in 1)), limiting it to be between the upper and lower bounds for that degree of freedom (in 3)),
5) a second Method, for specifying the state value for the joint along the second degree of freedom (in 2)); this value is not limited, as the upper and lower bounds are infinite, but is stored as a value modulus 360°,
6) a third Method, for specifying the magnitude of the bounds of the first degree of freedom (in 3)), which itself calls the first Method (in 4)) passing in the current state value along the first degree of freedom (in 2)).

1. A computer-implemented method for defining an oriented joint between two segments, a first segment considered the reference and a second segment considered mobile, wherein the relative position of the second, mobile, segment with respect to the first, reference, segment is specified by the positional state of the joint with respect to each of its degrees of freedom, such that the orientation of the joint can be reversed with respect to which joined segment is considered the reference and which is considered mobile and, having been reversed, the absolute position of the second, now reference, segment is identical to that same segment's absolute position when it was considered the mobile segment, and the absolute position of the first, now mobile, segment is identical to that same segment's absolute position when it was considered the reference segment.

2. A computer-implemented system for designing articulated assemblies comprised of reversible-orientation joints.

3. A computer-implemented system for simulating articulated assemblies comprised of reversible-orientation joints.

4. The method of claim 1, wherein the possible relative positions of the reference and mobile segments as defined by the degrees of freedom of the joint in a first orientation are the same as the possible relative positions of the reference and mobile segments as defined by the degrees of freedom of the joint in a second, reversed, orientation.

5. The method of claim 1, wherein the possible relative positions of the reference and mobile segments as defined by the degrees of freedom of the joint in a first orientation differ from the possible relative positions of the reference and mobile segments as defined by the degrees of freedom of the joint in a second, reversed, orientation.

6. The method of claim 1, wherein sets of data corresponding to the positional state of the joint with respect to its degrees of freedom are maintained for both the reversed and the unreversed orientations simultaneously and additional state information indicates which orientation the joint is considered to have, and the set of data corresponding to the positional state of the joint used to compute the absolute position of the segment considered to be mobile given an absolute position of the segment considered to be the reference is determined by the orientation the joint is considered to have at the time the computation is performed.

7. The method of claim 6, wherein the state information indicating which orientation the joint is considered to have is maintained in the joint.

8. The method of claim 6, wherein the state information indicating which orientation the joint is considered to have is provided at the time the computation of the absolute position of the mobile segment is requested.

9. The method of claim 1, wherein the joint has three degrees of rotational freedom: a first degree of freedom allowing the mobile segment to rotate about an axis perpendicular to the reference segment's length, a second degree of freedom allowing the mobile segment to rotate about an axis parallel to the reference segment's length, and a third degree of freedom allowing the mobile segment to rotate about an axis parallel to the mobile segment's length.

10. The method of claim 1, wherein the coordinate system used to define the position and degrees of freedom of the joint in a first orientation is the same as the coordinate system used to define the position and degrees of freedom of the joint in a second, reversed, orientation.

11. The method of claim 1, wherein the coordinate system used to define the position and degrees of freedom of the joint in a first orientation differs from the coordinate system used to define the position and degrees of freedom of the joint in a second, reversed, orientation.

12. The method of claim 1, wherein the number of degrees of freedom of the joint in a first orientation is the same as the number of degrees of freedom of the joint in a second, reversed, orientation.

13. The method of claim 1, wherein the number of degrees of freedom of the joint in a first orientation differs from the number of degrees of freedom of the joint in a second, reversed, orientation.

14. The method of claim 1, wherein the ranges of the degrees of freedom of the joint in a first orientation are the same as the ranges of the degrees of freedom of the joint in a second, reversed, orientation.

15. The method of claim 1, wherein the ranges of the degrees of freedom of the joint in a first orientation differ from the ranges of the degrees of freedom of the joint in a second, reversed, orientation.
